(19) United States
(12) Patent Application Publication
(10) Pub. No.: US 2026/0302044 A1
(43) Pub. Date: Oct. 1, 2026

(54) COIL COMPONENT

(71) Applicant: TDK Corporation, Tokyo (JP)

(72) Inventors: Hokuto EDA, Tokyo (JP); Kohei TAKAHASHI, Tokyo (JP); Takahiro NEMOTO, Tokyo (JP); Yuma USAMI, Tokyo (JP); Ryota ISHIKAWA, Tokyo (JP)

(73) Assignee: TDK Corporation, Tokyo (JP)

(21) Appl. No.: 19/578,277

(22) Filed: Mar. 25, 2026

(30) Foreign Application Priority Data
Mar. 27, 2025 (JP) 2025-053756

(51) Int. Cl. H01F 27/28

(52) U.S. Cl. CPC H01F 27/2823

(57) ABSTRACT

In a coil component, a concentration of a first magnetic powder in a proximal region of an element body is lower than in a distal region. In magnetic powder constituting the element body, the first magnetic powder has a largest average particle size, and it is considered that when a resin wall or a protective film is broken, it is broken by the first magnetic powder. In the coil component, by making the concentration of the first magnetic powder in the proximal region relatively lower than the concentration of the first magnetic powder in the distal region, a situation where the resin wall or the protective film located in the proximal region is broken by the first magnetic powder is suppressed.

This application is based upon and claims the benefit of priority from Japanese Patent Application No. 2025-53756, filed on 27 Mar. 2025, the entire contents of which are incorporated herein by reference.

### TECHNICAL FIELD

The present disclosure relates to a coil component.

### BACKGROUND

Japanese Unexamined Patent Application Publication No. 2016-208002 discloses a coil component in which a coil unit is disposed within an element body including a plurality of types of magnetic powders having different particle sizes from each other. The coil unit is configured to include a substrate, a coil pattern provided on the substrate, and an insulating layer covering the coil pattern.

### SUMMARY

In the coil component as described above, when the insulating layer covering the coil pattern is broken by the magnetic powder constituting the element body, the insulation property of the coil pattern deteriorates.

According to the present disclosure, a coil component with improved insulation property is provided.

A coil component according to one aspect of the present disclosure includes an element body including a plurality of types of magnetic powders having different average particle sizes, the magnetic powders including a first magnetic powder having a largest average particle size, and a coil unit disposed within the element body and including a coil and an insulating film constituting at least a part of a surface of the coil unit. A concentration of the first magnetic powder in a proximal region of the element body adjacent the insulating film of the coil unit is lower than that in a distal region of the element body remote from the insulating film.

### BRIEF DESCRIPTION OF THE DRAWINGS

FIG. 1 is a perspective view showing a coil component according to an embodiment.

FIG. 2 is a cross-sectional view showing the coil component of FIG. 1.

FIG. 3 is a diagram showing magnetic powders constituting an element body of the coil component shown in FIG. 1.

FIG. 4 is an enlarged cross-sectional view of a main part showing the element body of the coil component shown in FIG. 1 with the magnetic powders of FIG. 3.

FIG. 5 is an enlarged cross-sectional view of a main part in FIG. 4.

FIG. 6 is an enlarged cross-sectional view of a main part in FIG. 4.

### DETAILED DESCRIPTION

Hereinafter, embodiments of the present disclosure will be described in detail with reference to the accompanying drawings. Note that in the description of the drawings, the same or corresponding elements are denoted by the same reference numerals, and redundant description is omitted.

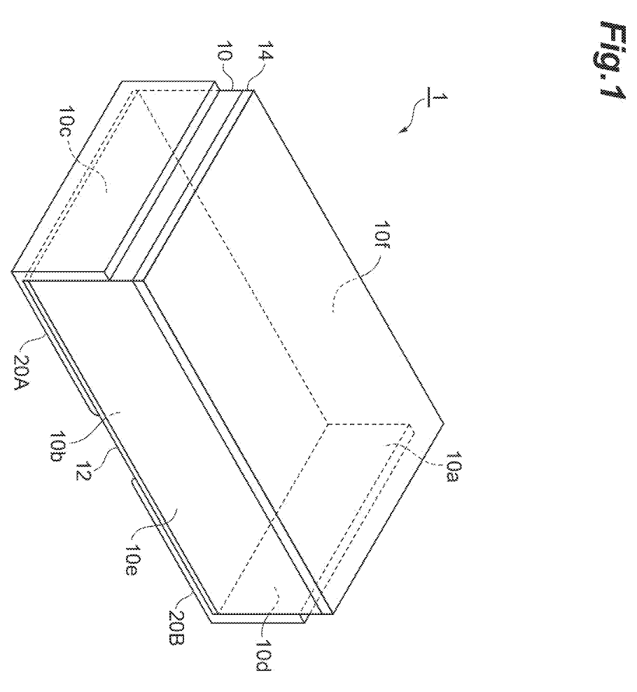

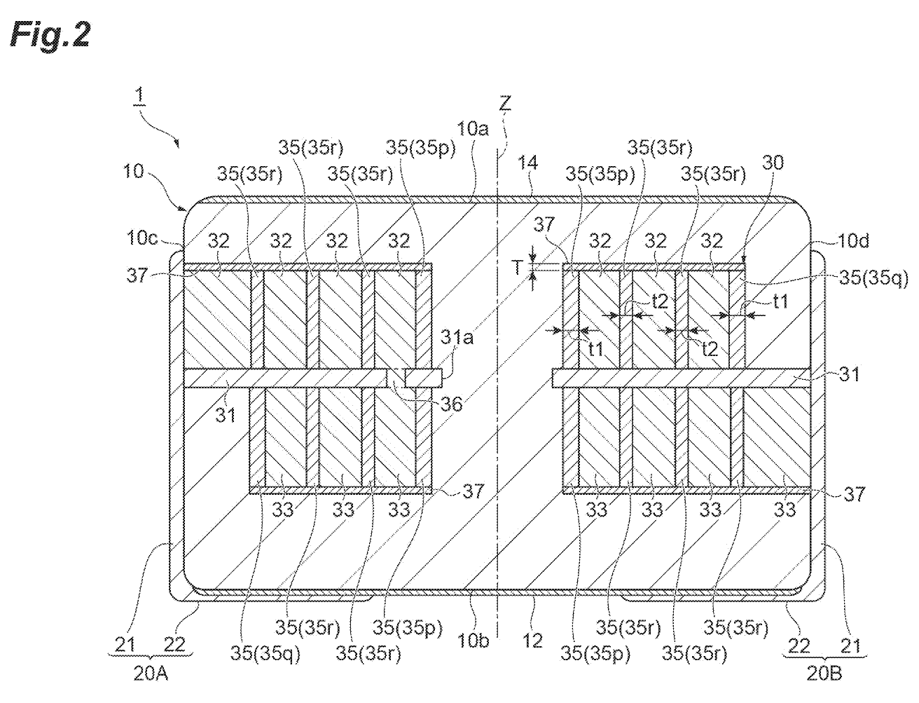

A coil component according to the present embodiment will be described with reference to FIG. 1. As shown in FIGS. 1 and 2, a coil component 1 according to an embodiment is configured to include an element body 10, a pair of terminal electrodes 20A and 20B, and a coil unit 30.

The element body 10 has a rectangular parallelepiped outer shape, and has a pair of main surfaces 10a and 10b parallel to each other, and four side surfaces 10c, 10d, 10e, and 10f connecting the pair of main surfaces 10a and 10b to each other. The rectangular parallelepiped shape in this specification includes a shape of a rectangular parallelepiped in which corner portions and ridge line portions are chamfered, and a shape of a rectangular parallelepiped in which corner portions and ridge line portions are rounded. One main surface 10b of the pair of main surfaces 10a and 10b is a surface facing a mounting substrate on which the coil component 1 is mounted, and is also referred to as a mounting surface in the following description. Each of the main surfaces 10a and 10b has a rectangular shape having a long side and a short side, and in the following description, the side surfaces 10c and 10d connecting the short sides of the main surfaces 10a and 10b are also referred to as end surfaces.

The element body 10 is composed of a magnetic powder-containing resin, which is a type of magnetic material. The magnetic powder-containing resin is a bonded powder in which magnetic powder, which will be described later, is bound by a binder resin. The binder resin is, for example, a thermosetting epoxy resin. In the present embodiment, the content of the magnetic powder in the bonded powder is 75 to 92 vol% in volume percent, and 95 to 99 wt% in mass percent. From the viewpoint of magnetic properties, the content of the magnetic powder in the bonded powder may be 80 to 92 vol% in volume percent, and 97 to 99 wt% in mass percent.

The pair of terminal electrodes 20A and 20B are L-shaped electrodes that continuously cover each of the end surfaces 10c and 10d and the mounting surface 10b of the element body 10. The terminal electrode 20A includes an end surface covering portion 21 that covers a part of the end surface 10c of the element body and a mounting surface covering portion 22 that covers a part of the mounting surface 10b on the end surface 10c side, and the end surface covering portion 21 and the mounting surface covering portion 22 constitute an L-shaped cross section. Similarly, the terminal electrode 20B also includes an end surface covering portion 21 that covers a part of the end surface 10d of the element body and a mounting surface covering portion 22 that covers a part of the mounting surface 10b on the end surface 10d side, and the end surface covering portion 21 and the mounting surface covering portion 22 constitute an L-shaped cross section.

The mounting surface 10b of the element body 10 is entirely covered by a covering material 12. That is, the entire region of the main surface 10b covered by the covering material 12 is not exposed to the outside. The mounting surface 10b in a region between the mounting surface covering portions 22 of the pair of terminal electrodes 20A and 20B is also covered by the covering material 12. The covering material 12 is interposed between the entire area of the mounting surface covering portions 22 of the terminal electrodes 20A and 20B and the mounting surface 10b. That is, the mounting surface covering portions 22 of the terminal electrodes 20A and 20B cover the covering material 12. The covering material 12 is composed of an insulating material such as an epoxy-based resin or an acrylic-based resin, and a short circuit between the pair of terminal electrodes 20A and 20B is prevented by the covering material 12.

The main surface 10a of the element body 10 is entirely covered by a covering material 14. That is, the entire region of the main surface 10a covered by the covering material 14 is not exposed to the outside. The covering material 14 is composed of an insulating material such as an epoxy-based resin or an acrylic-based resin. A constituent material of the covering material 14 that covers the main surface 10a may be the same as or different from a constituent material of the covering material 12 that covers the mounting surface 10b.

The coil unit 30 according to the present embodiment is disposed within the element body 10, as shown in FIG. 2. The coil unit 30 according to the present embodiment is configured to include an insulating substrate 31, planar coils 32 and 33 provided on both surfaces of the insulating substrate 31, a pair of extraction conductors 34A and 34B, a resin wall 35 provided on the insulating substrate 31, and a protective film 37 covering the planar coils 32 and 33.

The insulating substrate 31 extends parallel to the mounting surface 10b, and can be disposed, for example, at an intermediate position between the mounting surface 10b and the main surface 10a. The insulating substrate 31 has a through-hole 31a at a position through which a coil axis Z passes. The insulating substrate 31 extends between the side surface 10c and the side surface 10d, and is exposed from the side surface 10c and the side surface 10d. For the insulating substrate 31, a substrate in which a glass cloth is impregnated with a cyanate resin (BT (bismaleimide-triazine) resin: registered trademark) can be used. In addition, polyimide, aramid, epoxy, or the like can also be used in addition to the BT resin. As a material for the insulating substrate 31, ceramic or glass can also be used. As the material for the insulating substrate 31, a mass-produced printed circuit board material can be used, and a resin material used for a BT printed circuit board, an FR4 printed circuit board, or an FR5 printed circuit board can be used.

Both of the planar coils 32 and 33 are wound around the coil axis Z extending in a direction orthogonal to the mounting surface 10b. The planar coil 32 is wound for a plurality of turns around the coil axis Z on a main surface of the insulating substrate 31 on the main surface 10a side. The planar coil 33 is wound around the coil axis Z on a main surface of the insulating substrate 31 on the mounting surface 10b side. An inner peripheral end of the planar coil 32 and an inner peripheral end of the planar coil 33 are connected via a via conductor 36 provided at an edge of the through-hole 31a of the insulating substrate 31. An outer peripheral end of the planar coil 32 extends to the end surface 10c of the element body 10 and is electrically connected to the end surface covering portion 21 of the terminal electrode 20A that covers the end surface 10c. An outer peripheral end of the planar coil 33 extends to the end surface 10d of the element body 10 and is electrically connected to the end surface covering portion 21 of the terminal electrode 20B that covers the end surface 10d. The planar coil 32 and the planar coil 32 are wound such that current flows in the same direction (i.e., the same winding direction when viewed from the main surface 10a side of the element body 10) when a voltage is applied between the pair of terminal electrodes 20A and 20B. Since current flows in the same direction in the planar coil 32 and the planar coil 33, generated magnetic fluxes are superimposed and reinforce each other.

The resin wall 35 is provided on the main surface of the insulating substrate 31 on the main surface 10a side, and covers the planar coil 32 at an inner periphery, an outer periphery, and between windings of the planar coil 32. The resin wall 35 can be composed of a photoresist resin, and is composed of, for example, an epoxy-based resin. Among the resin walls 35, a resin wall 35p located at the inner periphery of the planar coil 32 covers an innermost turn of the planar coil 32, and a resin wall 35q located at the outer periphery of the planar coil 32 covers an outermost turn of the planar coil 32. Among the resin walls 35, a resin wall 35r located between the windings of the planar coil 32 separates an inner turn and an outer turn of the planar coil 32. In the present embodiment, a thickness t1 (i.e., a length in a direction parallel to the mounting surface 10b) of the resin walls 35p and 35q located at the inner periphery and the outer periphery of the planar coil 32 is designed to be thicker than a thickness t2 of the resin wall 35r located between the windings of the planar coil 32. A height (i.e., a length in a direction orthogonal to the mounting surface 10b) of the resin wall 35 may be the same as a height of the planar coil 32, or may be higher than the height of the planar coil 32.

The resin wall 35 is also provided on the main surface of the insulating substrate 31 on the mounting surface 10b side, and covers the planar coil 33 at an inner periphery, an outer periphery, and between windings of the planar coil 33. Among the resin walls 35, a resin wall 35p located at the inner periphery of the planar coil 33 covers an innermost turn of the planar coil 33, and a resin wall 35q located at the outer periphery of the planar coil 33 covers an outermost turn of the planar coil 33. Among the resin walls 35, a resin wall 35r located between the windings of the planar coil 33 separates an inner turn and an outer turn of the planar coil 33. A thickness of the resin walls 35p and 35q located at the inner periphery and the outer periphery of the planar coil 33 is designed to be thicker than a thickness of the resin wall 35r located between the windings of the planar coil 33. A height of the resin wall 35 may be the same as a height of the planar coil 33, or may be higher than the height of the planar coil 33.

The resin wall 35 functions as an insulating film constituting a surface of the coil unit 30 in a direction parallel to the mounting surface 10b, and insulation between the coil unit 30 and a constituent material of the element body 10 is achieved by the resin wall 35.

The protective film 37 covers the planar coil 32 exposed from between the resin walls 35 from the main surface 10a side. Specifically, the protective film 37 integrally covers the planar coil 32 and the resin wall 35 from the main surface 10a side. Similarly, the protective film 37 covers the planar coil 33 exposed from between the resin walls 35 from the mounting surface 10b side. Specifically, the protective film 37 integrally covers the planar coil 33 and the resin wall 35 from the mounting surface 10b side. In the present embodiment, the thicknesses t1 and t2 of the resin wall 35 are designed to be thicker than a thickness T (i.e., a length in a direction orthogonal to the mounting surface 10b) of the protective film 37.

The protective film 37 is composed of an insulating material, and can be composed of, for example, an insulating resin. In the present embodiment, the protective film 37 is configured to include an epoxy resin and an acrylic resin, and contains a silica filler. The protective film 37 functions as an insulating film constituting a surface of the coil unit 30 in a direction orthogonal to the mounting surface 10b, and insulation between the coil unit 30 and a constituent material of the element body 10 is achieved by the protective film 37.

Next, the magnetic powder of the magnetic powder-containing resin constituting the element body 10 will be described in detail.

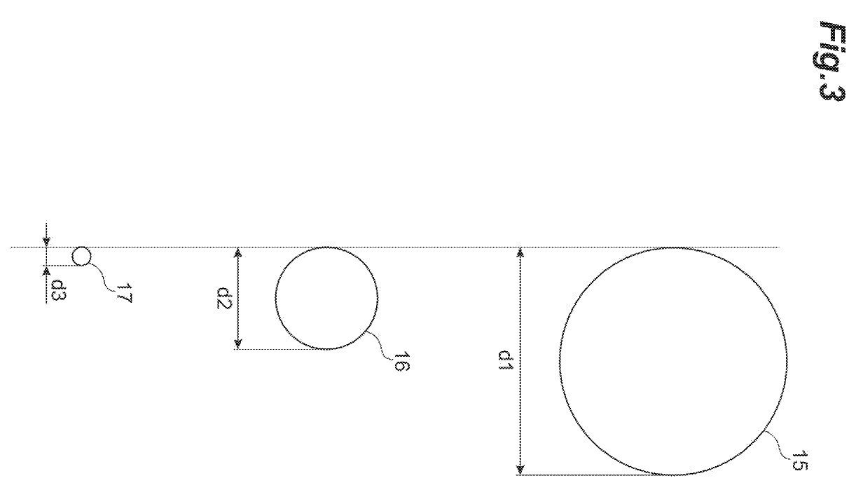

The magnetic powder of the magnetic powder-containing resin constituting the element body 10 is a mixed powder having a plurality of types of average particle sizes. In the present embodiment, the magnetic powder of the magnetic powder-containing resin constituting the element body 10 is a mixed powder of three types, a first magnetic powder 15, a second magnetic powder 16, and a third magnetic powder 17, as shown in FIG. 3.

The first magnetic powder 15 has a largest average particle size d1 among the first magnetic powder 15, the second magnetic powder 16, and the third magnetic powder 17. The average particle size d1 of the first magnetic powder 15 is 10 to 40 μm (for example, 25 μm). The first magnetic powder 15 can be composed of a metal or an alloy (including a nanocrystalline alloy and an amorphous alloy), and for example, pure iron, an iron alloy (iron-silicon alloy, iron-silicon-chromium alloy, Sendust alloy, Permalloy, carbonyl iron, iron-cobalt alloy), or the like can be used.

The second magnetic powder 16 has an average particle size d2 smaller than the average particle size d1 of the first magnetic powder 15. The average particle size d2 of the second magnetic powder 16 is 3 to 10 μm (for example, 5 μm). The second magnetic powder 16 can be composed of a metal or an alloy (including a nanocrystalline alloy and an amorphous alloy), and for example, pure iron, an iron alloy (iron-silicon alloy, iron-silicon-chromium alloy, Sendust alloy, Permalloy, carbonyl iron, iron-cobalt alloy), or the like can be used.

The third magnetic powder 17 has a smallest average particle size d3 among the first magnetic powder 15, the second magnetic powder 16, and the third magnetic powder 17. The average particle size d3 of the third magnetic powder 17 is 0.1 to 3 μm (for example, 2 μm). The third magnetic powder 17 can be composed of a metal or an alloy (including a nanocrystalline alloy and an amorphous alloy), and for example, pure iron, an iron alloy (iron-silicon alloy, iron-silicon-chromium alloy, Sendust alloy, Permalloy, carbonyl iron), or the like can be used.

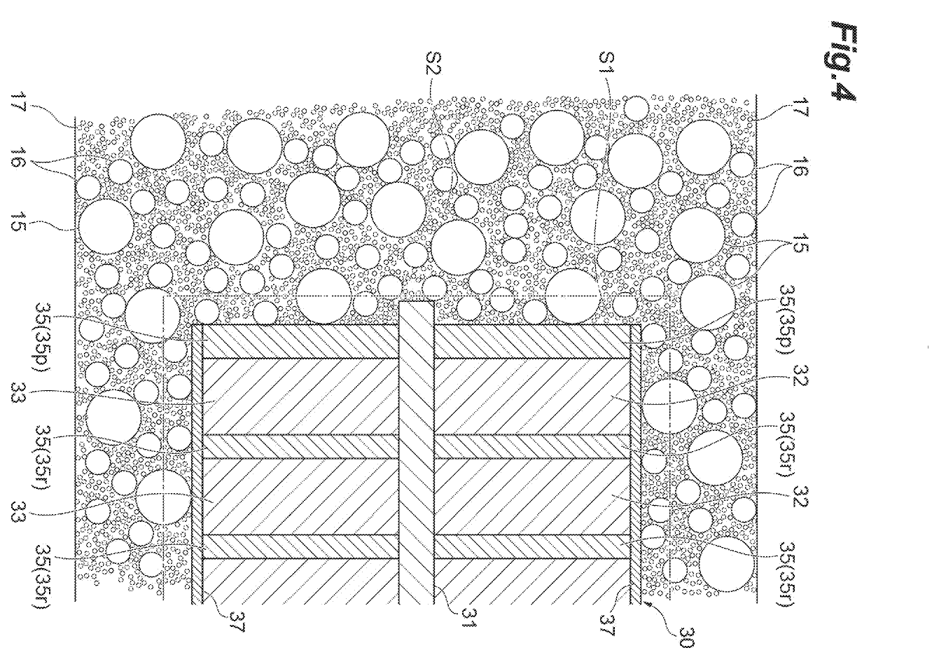

The element body 10 is formed by pressing a magnetic powder-containing resin including the first magnetic powder 15, the second magnetic powder 16, and the third magnetic powder 17 from a vertical direction (a direction orthogonal to the mounting surface 10b) such that the coil unit 30 is embedded therein. Thereby, as shown in FIG. 4, the magnetic powder-containing resin including the first magnetic powder 15, the second magnetic powder 16, and the third magnetic powder 17 covers an entire periphery of the coil unit 30, including an inner peripheral side (i.e., a coil axis Z side), an outer peripheral side (i.e., side surfaces 10c to 10f side), an upper side (i.e., a main surface 10a side), and a lower side (i.e., a mounting surface 10b side).

The element body 10 is distinguished into a proximal region S1 adjacent the coil unit 30 and a distal region S2 remote from the coil unit 30. More specifically, the proximal region S1 is a region adjacent the resin wall 35 and the protective film 37, which are insulating films constituting the surface of the coil unit 30. More specifically, the distal region S2 is a region remote from the resin wall 35 and the protective film 37 of the coil unit 30. Then, a concentration of the first magnetic powder 15 is different between the proximal region S1 and the distal region S2 within the element body 10, and the concentration of the first magnetic powder 15 in the proximal region S1 is lower than that in the distal region S2. Note that the first magnetic powder 15, the second magnetic powder 16, and the third magnetic powder 17 in the proximal region S1 and the distal region S2 may be uniformly dispersed or may be somewhat unevenly distributed.

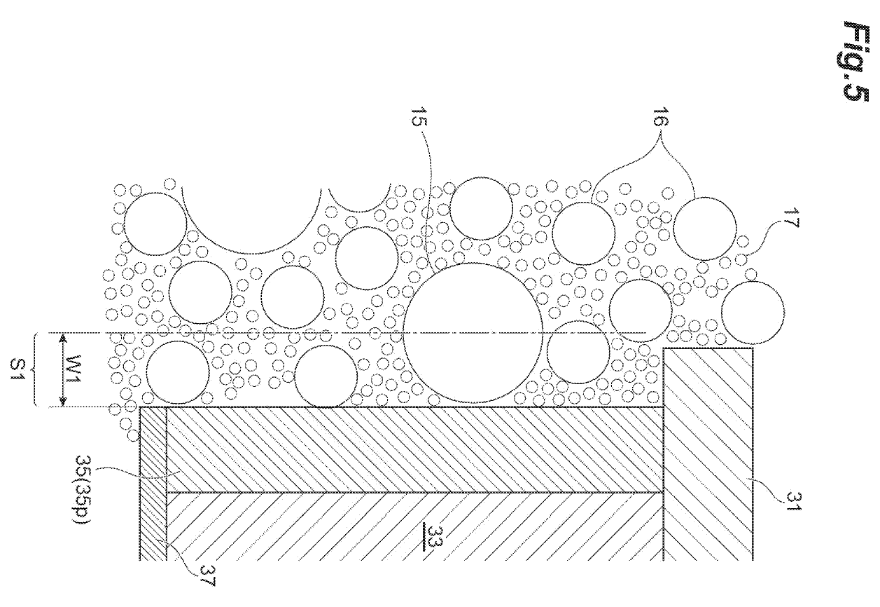

FIG. 5 shows the proximal region S1 adjacent the resin wall 35 that constitutes the surface of the coil unit 30 in a direction parallel to the mounting surface 10b. The proximal region S1 adjacent the resin wall 35 has a predetermined width W1, and the width W1 can be defined as, for example, half a length of the average particle size d1 of the first magnetic powder 15. A concentration of the first magnetic powder 15 in the proximal region S1 adjacent the resin wall 35 is lower than a concentration of the first magnetic powder 15 in the distal region S2. The concentration of the first magnetic powder 15 in the proximal region S1 adjacent the resin wall 35 is, for example, 55% to 75% (for example, 65%). In other words, in the proximal region S1, a concentration of the second magnetic powder 16 and the third magnetic powder 17, which are magnetic powders other than the first magnetic powder 15 (residual magnetic powders), is higher than in the distal region S2.

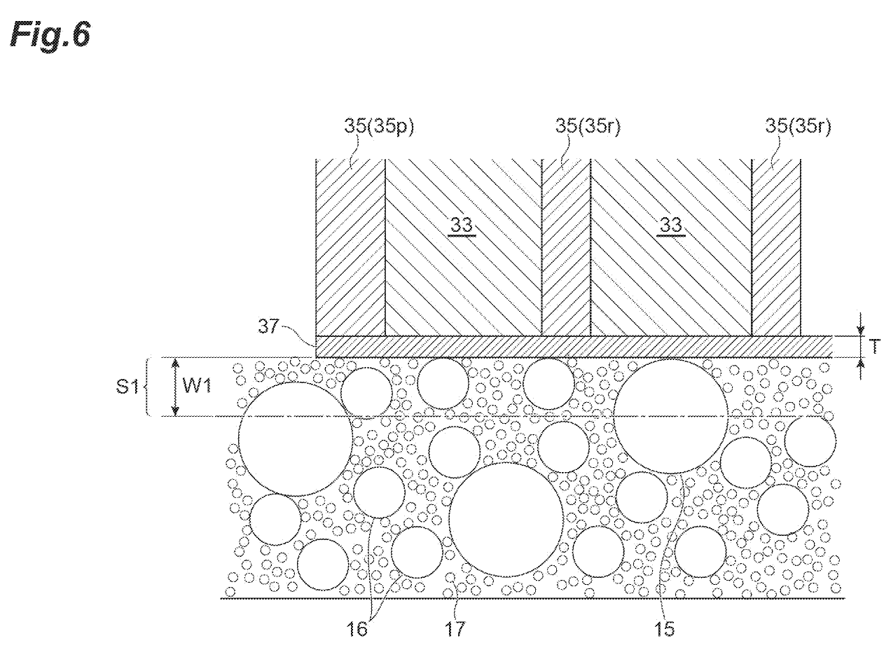

FIG. 6 shows the proximal region S1 adjacent the protective film 37 that constitutes the surface of the coil unit 30 in a direction orthogonal to the mounting surface 10b. The proximal region S1 adjacent the protective film 37 also has a predetermined width W1, similar to the proximal region S1 adjacent the resin wall 35, and the width W1 can be defined as, for example, half a length of the average particle size d1 of the first magnetic powder 15. Similar to the concentration of the first magnetic powder 15 in the proximal region S1 adjacent the resin wall 35, a concentration of the first magnetic powder 15 in the proximal region S1 adjacent the protective film 37 is also lower than the concentration of the first magnetic powder 15 in the distal region S2. The concentration of the first magnetic powder 15 in the proximal region S1 adjacent the protective film 37 is, for example, 55% to 75% (for example, 65%). In other words, also in the proximal region S1 adjacent the protective film 37, a concentration of the second magnetic powder 16 and the third magnetic powder 17, which are magnetic powders other than the first magnetic powder 15 (residual magnetic powders), is higher than in the distal region S2.

As described above, in the coil component 1, the concentration of the first magnetic powder 15 in the proximal region S1 is lower than in the distal region S2. In the magnetic powder constituting the element body 10, the first magnetic powder 15 has the largest average particle size d1, and it is considered that when the resin wall 35 or the protective film 37 is broken, it is broken by the first magnetic powder 15. For example, when the element body 10 is press-molded, it is conceivable that the magnetic powder constituting the magnetic powder-containing resin flows around the coil unit 30. At this time, it is considered that the first magnetic powder 15, which is larger than the second magnetic powder 16 and the third magnetic powder 17, causes greater damage to the coil unit 30. Therefore, in the coil component 1, by making the concentration of the first magnetic powder 15 in the proximal region S1 relatively lower than the concentration of the first magnetic powder 15 in the distal region S2, a situation where the resin wall 35 or the protective film 37 located in the proximal region S1 is broken by the first magnetic powder 15 is suppressed.

If the protective film 37 shown in FIG. 6 is broken by the first magnetic powder 15, it is conceivable that turns located on both sides of the resin wall 35r (an inner turn and an outer turn) become electrically conductive via the first magnetic powder 15. To prevent such electrical conduction, the thickness t2 of the resin wall 35r can be designed to be thicker than the average particle size d1 of the first magnetic powder 15. In this case, even if the protective film 37 is broken by the first magnetic powder 15, a situation where the inner turn and the outer turn become electrically conductive is suppressed.

Note that the coil component 1 may be an L-shaped electrode type provided with the terminal electrodes 20A and 20B that continuously cover each of the end surfaces 10c and 10d and the mounting surface 10b of the element body 10 shown in FIG. 1, or may be a bottom electrode type in which the terminal electrodes 20A and 20B are provided only on the mounting surface 10b of the element body 10. In this case, outer peripheral ends of the planar coils 32 and 33 of the coil unit 30 are both extracted to the mounting surface 10b of the element body 10 and are electrically connected to the terminal electrodes 20A and 20B provided on the mounting surface 10b.

The present disclosure is not limited to the embodiments described above, and can be variously modified. For example, the magnetic powder of the magnetic powder-containing resin constituting the element body of the coil may be a mixed powder of two types of magnetic powders having different average particle sizes, or may be a mixed powder of four or more types of magnetic powders having different average particle sizes. The coil is not limited to the form described above, and may be, for example, a form that does not include a substrate. Further, the coil may be wound around a coil axis parallel to the mounting surface.

What is claimed is:

1. A coil component, comprising:
an element body including a plurality of types of magnetic powders having different average particle sizes, the magnetic powders including a first magnetic powder having a largest average particle size; and
a coil unit disposed within the element body and including a coil and an insulating film constituting at least a part of a surface of the coil unit,
wherein a concentration of the first magnetic powder in a proximal region of the element body adjacent the insulating film of the coil unit is lower than that in a distal region of the element body remote from the insulating film.

2. The coil component according to claim 1, wherein the coil unit comprises:
a substrate provided with the coil on a main surface of the substrate;
a resin wall provided on the main surface of the substrate and covering the coil at least at an inner periphery and an outer periphery of the coil; and
a protective film covering a surface of the coil exposed from between the resin wall in a thickness direction of the substrate,
wherein the insulating film of the coil unit is the resin wall or the protective film.

3. The coil component according to claim 2, wherein the resin wall is thicker than the protective film.

4. The coil component according to claim 2, wherein the resin wall covers the coil at an inner periphery, an outer periphery, and between windings of the coil, and a thickness of the resin wall located between the windings is thicker than a particle size of the first magnetic powder.

5. The coil component according to claim 1, wherein a concentration of the first magnetic powder in the magnetic powder of the proximal region is 55% to 75%.
